(19) United States
(12) Patent Application Publication
(10) Pub. No.: US 2026/0091349 A1
(43) Pub. Date: Apr. 2, 2026

(54) METHOD OF PRODUCING A NITROGEN ENRICHED STREAM FROM AN ELECTROCHEMICAL SYSTEM

(71) Applicant: Robert Bosch GmbH, Stuttgart (DE)

(72) Inventors: Karim GADELRAB, Watertown, MA (US); Ulrich BERNER, Stuttgart (DE); Matthias HANAUER, Leonberg (DE); Ulrich SAUTER, Karlsruhe (DE)

(21) Appl. No.: 18/899,512

(22) Filed: Sep. 27, 2024

(51) Int. Cl. B01D 53/32; G01N 27/48; H01M 8/04223; H01M 8/04276; H01M 8/04303; H01M 8/04664; H01M 8/04746; H01M 8/10

(52) U.S. Cl. CPC B01D 53/326; G01N 27/48; H01M 8/04231; H01M 8/04276; H01M 8/04303; H01M 8/04671; H01M 8/04753; B01D 2256/10; B01D 2257/104; H01M 2008/1095

(57) ABSTRACT

A method of producing a nitrogen enriched stream from an electrochemical system. The method includes operating the electrochemical system in an operating state, operating the electrochemical system in a bleed down state to produce a nitrogen enriched stream on a cathode side of the electrochemical system, and exhausting the nitrogen enriched stream from the cathode side of the electrochemical system through an exhaust valve to produce the nitrogen enriched stream from the electrochemical system. The produced nitrogen gas may be used to purge, blanket, cool, and/or diagnose state of health (SoH) of an electrochemical system such as a PEMFC system.

### TECHNICAL FIELD

The present disclosure relates to a method of producing a nitrogen enriched stream from an electrochemical system. The nitrogen enriched stream may be exhausted from the electrochemical system and used to purge, blanket, cool, and/or diagnose state of health (SoH) of the electrochemical system.

### BACKGROUND

Making up 78% by volume in air, nitrogen is abundantly available on earth. Nitrogen is extensively applied in the chemical industry. Nitrogen gas finds widespread applications in the chemical industry to provide an inert atmosphere for chemical reactions, storage, and transportation of materials. Nitrogen gas can be used to purge chemical processing equipment and pipelines by helping to displace air and create an oxygen-free environment. Nitrogen gas can also be used as a reactant in chemical production (e.g., a feed gas for the synthesis of ammonia).

There are several known large-scale nitrogen production processes in commercial settings. Some of the more commonly used methods include cryogenic separation and pressure-swing adsorption.

Cryogenic separation includes cooling air to extremely low temperatures and causing the different components of air to liquefy and separate based on their boiling points. Cryogenic separation is frequently employed in large air separation plants to yield nitrogen with exceptional purity levels (e.g., 99.9999%). However, due to substantial space requirements, substantial costs, and energy consumption associated with building cryogenic facilities, there has been a growing interest in alternatives to cryogenic separation processes.

Pressure-swing adsorption uses selective adsorption properties of different porous materials (e.g., zeolites or activated carbon) to separate nitrogen from other components in air. Pressure-swing adsorption can produce nitrogen gas with varying purity (e.g., 95% to 99.999%) based on the operating parameters and the specific adsorbent materials used. Pressure-swing adsorption processes may suffer from relatively high costs due to adsorbent degradation and replacement and relatively high energy consumption.

### SUMMARY

According to one embodiment, a method of producing a nitrogen enriched stream from an electrochemical system is disclosed. The method includes operating the electrochemical system in an operating state. The electrochemical system includes an anode side and a cathode side. The anode side includes an anode and an anode inlet flowing an anode reactant to the anode. The anode side includes an anode outlet outletting an anode excess amount of the anode reactant from the anode. The cathode side includes a cathode and a cathode inlet flowing a cathode reactant to the cathode. The cathode side includes a cathode outlet outletting a cathode excess amount of the cathode reactant and/or a cathode reactant from the cathode. The anode inlet, the anode outlet, the cathode inlet, and the cathode outlet are in open positions in the operating state. The method further includes operating the electrochemical system to produce a nitrogen enriched stream on the cathode side of the electrochemical system. The method also includes exhausting the nitrogen enriched stream from the cathode side of the electrochemical system through an exhaust valve to produce the nitrogen enriched stream from the electrochemical system.

According to a second embodiment, a method of producing a nitrogen enriched stream from an electrochemical system is disclosed. The method includes flowing an anode reactant through an anode side of the electrochemical system and a cathode reactant through a cathode side of the electrochemical system. The method further includes lowering the cathode reactant through the cathode side of the electrochemical system while continuing the flow of the anode reactant through the anode side of the electrochemical system to produce a nitrogen enriched stream on the cathode side of the electrochemical system. The method also includes exhausting the nitrogen enriched stream from the cathode side of the electrochemical system through an exhaust valve to produce the nitrogen enriched stream from the electrochemical system.

According to yet another embodiment, a method of producing a nitrogen enriched stream from an electrochemical system is disclosed. The method includes providing the electrochemical system with a first electrochemical stack and a second electrochemical stack. The method further includes flowing an anode reactant through an anode side of the first electrochemical stack and a cathode reactant through a cathode side of the first electrochemical stack. The method also includes lowering the cathode reactant through the cathode side of the first electrochemical stack while continuing the flow of the anode reactant through the anode side of the first electrochemical stack to produce a nitrogen enriched stream on the cathode side of the first electrochemical stack. The method also includes exhausting the nitrogen enriched stream from the cathode side of the first electrochemical stack through an exhaust value to produce the nitrogen enriched stream from the first electrochemical stack. The method also includes applying nitrogen from the nitrogen enriched stream to a second electrochemical stack to run a diagnostic test on the second electrochemical stack.

### BRIEF DESCRIPTION OF THE DRAWINGS

FIG. 1 depicts a schematic, side view of certain components of an individual polymer electrolyte membrane fuel cell (PEMFC) in an operational state according to one embodiment.

FIG. 2 depicts a schematic, side view of the individual PEMFC of FIG. 1 in a bleed down state according to one embodiment.

FIG. 3 depicts a flowchart of uses for exhausted nitrogen from an electrochemical cell.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may, of course, vary. Furthermore, the terminology used herein is used only for the purpose of describing embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

Known commercial size nitrogen production processes (e.g., cryogenic separation) may have one or more drawbacks (e.g., high cost and space requirements to obtain high purity levels) that make the processes inapplicable under some circumstances. Polymeric membrane separation technology may be used as a means of satisfying the demands of smaller to medium-sized air separation plants that do not necessitate ultra-high purity levels.

Polymeric membrane separation may separate nitrogen and oxygen based on their concentration or partial pressure gradient across the membrane. The separation may be achieved through a solution diffusion mechanism, which may be controlled by the permeability and selectivity of the polymeric membrane. However, the kinetic diameter of oxygen and nitrogen is very similar, which makes it challenging to achieve a high permselectivity with polymeric membranes. Permselectivity refers to the degree in which the polymeric membrane permits passage of certain ions and/or molecules while blocking the passage of other ions and/or molecules. Additionally, these membranes are limited by their poor chemical and thermal stability when used for gas separation.

Many of the possible approaches of nitrogen generation raise issues relating to the logistics of nitrogen transport. Nitrogen transport is an additional layer of complexity to the utilization of nitrogen (N₂) in different applications. Nitrogen is typically transported as compressed gas in high-pressure cylinders, or in liquid form in special purpose tanker trucks. Mobile generation and on-demand utilization of nitrogen is currently not common and achieving this can create applications such as blanketing and purging gas to protect valuable products from contaminants. With the expected widespread adoption of hydrogen as a fuel, nitrogen can be employed in protecting electronic control units, provide inert cooling systems, and as a control gas to run local system diagnostics for state of health measurements in fuel cells.

In one or more embodiments, a method of producing a nitrogen enriched stream from an electrochemical system is disclosed. One or more of the disclosed methods may be employed in mobile units include vehicles, trucks, buses, vans, emergency backup power units, boats, drones, and/or computing devices. In one or more embodiments, the electrochemical system may be a fuel cell system. The fuel cell system may be a polymer electrolyte membrane fuel cell (PEMFC) system. The nitrogen enriched stream may be used to purge, blanket, cool, and/or diagnose state of health (SoH) of an electrochemical system such as a PEMFC system. In one or more embodiments, a nitrogen enriched stream refers to a gas having a volume of nitrogen higher than the volume of nitrogen in air (78%). In one or more embodiments, the volume of nitrogen in the nitrogen enriched stream may be any of the following volumes or in a range of any two of the following volumes: 80%, 81%, 82%, 83%, 84%, 85%, 86%, 87%, 88%, 89%, 90%, 91%, 92%, 93%, 94%, 95%, 96%, 97%, 98%, and 99%.

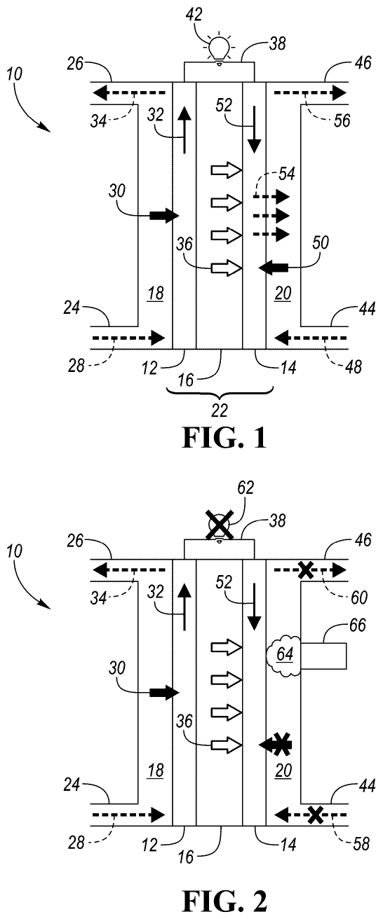

FIG. 1 depicts a schematic, side view of certain components of an individual PEMFC 10 in an operational state according to one embodiment. A number of individual PEMFCs 10 may be combined to form a fuel cell stack. As shown in FIG. 1, PEMFC 10 includes anode 12, cathode 14, and polymer electrolyte membrane (PEM) 16 extending between anode 12 and cathode 14. A catalyst material, such as platinum, is used in anode 12 and cathode 14. PEMFC also includes first and second gas diffusion layers (GDLs) 18 and 20. Anode 12, cathode 14, PEM 16, and first and second GDLs 18 and 20 comprise membrane electrode assembly 22. In the operational state, the PEMFC is consuming hydrogen fuel to generate power while air is flowing through the cathode.

Anode inlet 24 and anode outlet 26 are in fluid communication with flow channels and first GDL 18, which is in fluid communication with anode 12. In the operational state of PEMFC 10, anode inlet 24 and anode outlet 26 are in open positions. As signified by arrow 28, anode inlet 24 is configured to flow fuel (e.g., hydrogen (H₂) fuel) into PEMFC 10 through flow channels and first GDL 18 and into anode 12 (as signified by arrow 30). The anode fuel undergoes electrochemical oxidation in the presence of a catalyst to split the H₂ into protons (H⁺) and electrons (e⁻) (as signified by arrow 32). Excess anode fuel exits PEMFC 10 through anode outlet 34 as represented by arrow 34. As represented by arrows 36, the protons (H⁺) are transported through PEM 16 to cathode 14, while the electrons (e⁻) flow through external circuit 38 to cathode 14 (as shown by arrow 40). The flow of electrons (e⁻) through external circuit 38 generates an electrical current to power electrical device 42 or charge a battery.

Cathode inlet 44 and cathode outlet 46 are in fluid communication with flow channels and second GDL 20, which is in fluid communication with cathode 14. In the operational state of PEMFC 10, cathode inlet 44 and cathode outlet 46 are in open positions. As represented by arrow 48, cathode inlet 44 is configured to flow air into PEMFC 10 through flow channels and second GDL 20 and into cathode 14 (as signified by arrow 50). The oxygen (O₂) fed to cathode 14 reacts with the protons (H⁺) that traveled through PEM 16. The electrons (e⁻) that flowed through external circuit 38 as shown by arrow 52 from a water byproduct as shown by arrows 54. The water byproduct and excess air exit cathode 14 and PEMFC 10 through cathode outlet 46 as represented by arrow 56.

FIG. 2 depicts a schematic, side view of individual PEMFC 10 of FIG. 1 in a bleed down state according to one embodiment. In the bleed down state, as represented by crossed out arrows 58 and 60, cathode inlet 44 and cathode outlet 46, respectively, are in a closed positions for a bleed down period while hydrogen continues to flow through anode 12. The bleed down period may last for any of the following periods or in a range of any two of the following periods: 1, 2, 3, 4, 5, 6, 7, 8, 9, 10, 11, 12, 13, 14, 15, 16, 17, 18, 19, and 20 seconds. In other embodiments, the bleed down period may last any of the following period or in a range of any two of the following periods: 0.5, 0.6, 0.7, 0.8, 0.9, 1.0, 1.5, 2.0, 2.5, 3.0, 3.5, 4.0, 4.5, and 5.0 minutes. In the bleed down state, the electrochemical reaction consumes the oxygen at cathode 14 until the system voltage drops to a negligible level as signified by cross 62 while nitrogen 64 remains on the cathode side of PEMFC 10. The remaining nitrogen 64 may be used to purge, blanket, cool, and/or diagnose state of health (SoH) of a PEMFC system. The remaining nitrogen 64 may be exhausted through nitrogen exhaust 66 (e.g., a nitrogen enriched stream) to achieve one or more of the tasks set forth herein in one or more embodiments. Nitrogen exhaust 66 may include one or more pneumatic components (e.g., valves) configured to exhaust the nitrogen enriched stream.

During the operating state of the PEMFC as depicted in FIG. 1, power is generated by using hydrogen as fuel as it reacts with the oxygen in the air flowing at the cathode side. In the bleed down state of the PEMFC as depicts in FIG. 2, the PEMFC cathode valves are shut to produce a nitrogen enriched stream on the cathode side while hydrogen is flowing at the anode. The bleed down state results in the consumption of remaining oxygen in a confined cathode environment, thereby reducing the power output of the PEMFC. Eventually, humid nitrogen remains in the cathode environment. The relative humidity of the remaining nitrogen may be any of the following values or in a range of any two of the values: 10%, 20%, 30%, 40%, 50%, 60%, 70%, 80%, 90%, and 100%. The humidity of the nitrogen enriched stream may be reduced by a dehumidification device configured to reduce water moisture and/or vapor from the nitrogen enriched stream. The nitrogen enriched stream may be filtered using a filter gas other than nitrogen to further increase the purity of the nitrogen in the nitrogen enriched steam. In one or more embodiments, the nitrogen enriched stream may be filtered after reduction of the humidity of the nitrogen enriched stream.

In another embodiment, the electrochemical system may be operated in a substoichiometric mode in which the cathode inlet and outlet are open but the oxygen stoichiometry at a given current is lower than 1, and in some embodiments, lower than 0.9. In this embodiment, a continuous flow of oxygen depleted (i.e., nitrogen rich) gas exits the cathode outlet.

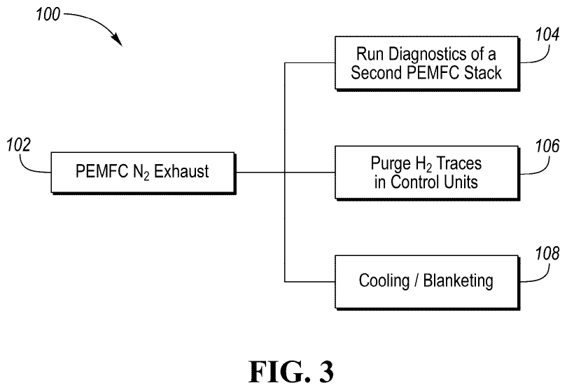

FIG. 3 depicts flowchart 100 including uses for a nitrogen enriched stream from an electrochemical cell. Operation 102 includes exhausting the nitrogen enriched stream from a PEMFC. Operations 102, 104, and 106 are operations that can be performed using the nitrogen enriched stream. One or more of these operations may be performed using the nitrogen enriched stream.

Operation 104 includes running diagnostics on a second PEMFC stack with the nitrogen enriched stream from a first PEMFC stack in a multi-stack PEMFC arrangement. The nitrogen enriched stream may be fed to a subsequent PEMFC stack cathode to run diagnostics in an H₂/N₂ environment (e.g., using conditions similar to laboratory conditions). Diagnostics may be achieved through voltage/current step cycling and analyzing the cell response or conducting a cyclic voltammetry test to estimate an electrochemical active surface area (ECSA). While operation 104 discloses one stack exhausting a nitrogen enriched stream for a diagnostic use on another stack, more than one stack may be exhausted, and the exhausted nitrogen enriched stream may be used on multiple other stacks. The nitrogen exhausted diagnostic tests may be carried out using voltage/current stepping or cyclic voltammetry.

Operation 106 includes purging traces of accumulated hydrogen in system components of a PEMFC using the nitrogen enriched stream. The nitrogen enriched stream may be used to purge hydrogen in system components such as control components in the PEMFC. The hydrogen build up may have gradual damaging effects on temperature sensors, semiconducting devices, and mechanical properties of metallic components. Purging hydrogen away from electronic components may reduce the likelihood of sparking and/or electronic discharge. Non-limiting examples of system components including one or more diagnostic components, monitoring components, humidification controls, air supply controls, hydrogen supply controls, thermal management components, power management units, and fuel cell controllers.

Operation 108 includes performing a cooling or blanketing function using the nitrogen enriched stream. The nitrogen may be used for fire blanketing or cooling of system components. Non-limiting examples of system components including one or more diagnostic components, monitoring components, humidification controls, air supply controls, hydrogen supply controls, thermal management components, power management units, and fuel cell controllers.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of producing a nitrogen enriched stream from an electrochemical system, the method comprising:
operating the electrochemical system in an operating state, the electrochemical system includes an anode side and a cathode side, the anode side includes an anode and an anode inlet flowing an anode reactant to the anode, the anode side includes an anode outlet outletting an anode excess amount of the anode reactant from the anode, the cathode side includes a cathode and a cathode inlet flowing a cathode reactant to the cathode, the cathode side includes a cathode outlet outletting a cathode excess amount of the cathode reactant and/or a cathode reactant from the cathode, and the anode inlet, the anode outlet, the cathode inlet, and the cathode outlet are in open positions in the operating state; and
operating the electrochemical system to produce a nitrogen enriched stream on the cathode side of the electrochemical system; and
exhausting the nitrogen enriched stream from the cathode side of the electrochemical system through an exhaust valve to produce the nitrogen enriched stream from the electrochemical system.

2. The method of claim 1, wherein the operating step includes operating the electrochemical system in a bleed down state to produce the nitrogen enriched stream on the cathode side of the electrochemical system, the anode inlet and the anode outlet are in open positions in the bleed down state, and the cathode inlet and the cathode outlet are in closed positions in the bleed down state.

3. The method of claim 1, wherein the first operating step occurs before the second operating step.

4. The method of claim 2, wherein the second operating step is performed for a period of time.

5. The method of claim 4, wherein the period of time is 1 to 20 seconds.

6. The method of claim 1 further comprising applying nitrogen from the nitrogen enriched stream to the electrochemical system to run a diagnostic test on the electrochemical system.

7. The method of claim 6, wherein the diagnostic test includes voltage/current step cycling and analyzing the response of the electrochemical system.

8. The method of claim 6, wherein the diagnostic test includes conducting a cyclic voltammetry test to estimate an electrochemical active surface area (ECSA).

9. The method of claim 1 further comprising purging hydrogen from one or more system components with nitrogen from the nitrogen enriched stream.

10. The method of claim 9, wherein the one or more system components include one or more diagnostic components, monitoring components, humidification controls, air supply controls, hydrogen supply controls, thermal management components, power management units, and fuel cell controllers.

11. The method of claim 1 further comprising cooling the electrochemical system using nitrogen from the nitrogen enriched stream.

12. The method of claim 1 further comprising blanketing the electrochemical system using nitrogen from the nitrogen enriched stream.

13. The method of claim 1, wherein the electrochemical system is a polymer electrolyte membrane fuel cell (PEMFC) system.

14. A method of producing a nitrogen enriched stream from an electrochemical system, the method comprising:
flowing an anode reactant through an anode side of the electrochemical system and a cathode reactant through a cathode side of the electrochemical system;
lowering the cathode reactant through the cathode side of the electrochemical system while continuing the flow of the anode reactant through the anode side of the electrochemical system to produce a nitrogen enriched stream on the cathode side of the electrochemical system; and
exhausting the nitrogen enriched stream from the cathode side of the electrochemical system through an exhaust valve to produce the nitrogen enriched stream from the electrochemical system.

15. The method of claim 14, wherein the lowering step includes lowering an oxygen stoichiometry to less than 1.

16. The method of claim 14, wherein the lowering step is a discontinuing step is performed for a period of time.

17. The method of claim 16, wherein the period of time is 1 to 20 seconds.

18. The method of claim 14, wherein the electrochemical system is a polymer electrolyte membrane fuel cell (PEMFC) system.

19. A method of producing a nitrogen enriched stream from an electrochemical system, the method comprising:
providing the electrochemical system with a first electrochemical stack and a second electrochemical stack;
flowing an anode reactant through an anode side of the first electrochemical stack and a cathode reactant through a cathode side of the first electrochemical stack;
lowering the cathode reactant through the cathode side of the first electrochemical stack while continuing the flow of the anode reactant through the anode side of the first electrochemical stack to produce a nitrogen enriched stream on the cathode side of the first electrochemical stack;
exhausting the nitrogen enriched stream from the cathode side of the first electrochemical stack through an exhaust valve to produce the nitrogen enriched stream from the first electrochemical stack; and
applying nitrogen from the nitrogen enriched stream to a second electrochemical stack to run a diagnostic test on the second electrochemical stack.

20. The method of claim 19, wherein the electrochemical system is a polymer electrolyte membrane fuel cell (PEMFC) system.
